(19) United States
(12) Patent Application Publication
(10) Pub. No.: US 2025/0296025 A1
(43) Pub. Date: Sep. 25, 2025

(54) SEPARATOR DEVICE

(71) Applicant: NEUFILTER GMBH, Gronau (DE)

(72) Inventors: Thomas BÖING, Gronau (DE); Daniel HENKE, Gronau (DE)

(21) Appl. No.: 18/686,391

(22) PCT Filed: Aug. 26, 2022
(86) PCT No.: PCT/EP2022/073839

§ 371 Date: Aug. 7, 2024

(30) Foreign Application Priority Data
Sep. 14, 2021 (DE) 20 2021 104 962.6

(51) Int. Cl. B01D 46/00; B01D 46/52

(52) U.S. Cl. CPC B01D 46/0016; B01D 46/521; B01D 2201/302

(57) ABSTRACT

The invention relates to a separator device (10) for separating particles entrained in a raw gas flow, comprising a frame (12) for receiving at least one separator element (14) and comprising two openings (20, 22) in the frame (12) in an operationally ready state. The frame material which closes the openings (20, 22) before the openings (20, 22) are opened functions as a first and second cover (24, 26), and the two covers (24, 26) can be combined in order to form a pre-separator unit (30) after the openings (20, 22) have been opened and can be arranged on the frame (12) in the region of the inflow opening (20).

### BACKGROUND OF THE INVENTION

### 1. Field of the Invention

The invention proposed here relates to the technical field of separating particles entrained in an air flow (raw gas flow), in particular separating paint particles entrained by what is known as a paint mist in the form of a raw gas flow (paint mist separation).

### 2. Description of Related Art

Devices, namely separator devices, are already known for this purpose, for example in the form of the separator device described in EP 2 532 409 B and described therein as a filter module, or in the form of the separator device described in DE 10 2014 003 608 A1 and also described therein as a filter module, or in the form of the device described in CN 209985061 U.

### SUMMARY OF THE INVENTION

One problem addressed by the proposed invention is that of specifying a further improved form of a separator device, in particular an improved form of the separator device known from EP 2 532 409 B or a comparable separator device.

A separator device which the invention proposed here takes as a starting point comprises an outer frame which receives a separator element or a plurality of separator elements in its interior. During operation, the raw gas flow loaded with particles flows through a separator device of this kind. The outer frame of the separator device accordingly comprises, in each case, a large-area opening for the entry of the raw gas flow (inflow opening) and for the exit of the raw gas flow (outflow opening).

The problem mentioned at the outset is solved according to the invention by a device, namely a separator device, having the features of claim 1. This is intended for separating particles entrained in a raw gas flow. It comprises a frame for receiving at least one separator element and the frame comprises at least two openings, namely an inflow opening and an outflow opening, in the operationally ready state.

The special feature of the separator device proposed here is that the frame material which closes the openings before these openings are opened can be used to obtain a pre-separator unit which can be attached to the separator device. In other words, the special feature is that frame material which closes the openings before these openings are opened can be used to obtain a pre-separator unit which can be attached to the separator device.

The frame material which closes the openings before these openings are opened is referred to in the following as a cover, and owing to the inflow opening and the outflow opening, two covers are produced (inflow opening cover, outflow opening cover). The two covers can be combined to form a pre-separator unit after the openings are opened and the covers or the pre-separator unit formed thereby can be arranged in the region of the inflow opening on the frame of the separator device. Because the pre-separator unit is formed by means of the two covers, they can also be referred to as pre-separator unit parts; the inflow opening cover is a first pre-separator unit part and the outflow opening cover is a second pre-separator unit part.

The problem mentioned at the outset is also solved according to the invention by a method for obtaining a pre-separator unit that can be used together with a separator device. The separator device comprises, as described above and in the following, a frame for receiving at least one separator element and comprises openings, namely an inflow opening and an outflow opening, in the frame in the operationally ready state. The frame material closing the openings before the openings are opened acts as the first cover and the second cover. To obtain the pre-separator unit, the two covers are combined with one another after the openings are opened and the resulting pre-separator unit is arranged on the frame in the region of one of the openings, namely the inflow opening.

The advantage of the invention proposed here is that the frame material (the covers) closing the openings is not discarded and instead is given a specific and useful purpose. By the covers being combined to form a pre-separator unit, this results in a further separator stage that can be used together with the separator device, such that the separating performance of the separator device is increased. Another advantage of the invention proposed here is that the combination of the covers to form a pre-separator unit and the attachment of the pre-separator unit to the separator device can be performed entirely without tools and also without a significant amount of time being required.

Overall, the invention proposed here is therefore also the use of frame material of a separator device intended for separating particles entrained in a raw gas flow as covers that can be combined to form a pre-separator unit, wherein the separator device comprises a frame for receiving at least one separator element and comprises two openings in the frame in the operationally ready state, and wherein the frame material closes the openings before these openings are opened. The covers or the frame material acting as a cover comprise individual features or all the features described in the following.

The proposed invention therefore lastly also includes the use of a separator device as described here and in the following together with a pre-separator unit, combined therewith and made of frame material of the separator device, for separating particles entrained in a raw gas flow.

The remaining claims relate to advantageous configurations of the invention. Dependency references used in this case within the claims refer to the further development of the subject matter of the claim in question by the features of the respective dependent claim. They are not to be understood as dispensing with achieving standalone protection of subject matter for the features or combinations of features in a dependent claim. Furthermore, with regard to an interpretation of the claims and the description when specifying a feature more precisely in a dependent claim, it should be assumed that a limitation of this kind is not found in the respectively preceding claims or a more general embodiment of the claimed device. Each reference in the description to aspects of dependent claims should therefore also be expressly interpreted as a description of optional features without this being specifically noted.

The separator device proposed here also includes a method for obtaining a pre-separator unit that can be used together with the separator device and the use of frame material of a separator device as covers that can be combined to form a pre-separator unit. To avoid any unnecessary repetition, it is applicable to the further description that features and details that are described in connection with the separator device or the pre-separator unit are of course also applicable in connection with and to a method for obtaining a pre-separator unit that can be used together with a separator device and with and to the use of frame material of a separator device as covers that can be combined to form a pre-separator unit, and vice versa. Accordingly, the method can also be developed by means of individual method features or a plurality of method features which relate to the function or the design of individual features or a plurality of features of the separator device or the pre-separator unit, and the separator device or the pre-separator unit can accordingly be developed by features that result on the basis of the method. Therefore, features and details which are described in conjunction with the method are of course also applicable in connection with and to the separator device or the pre-separator unit, and vice versa, and therefore mutual reference is always made or can be made to the individual aspects of the proposed invention with regard to the disclosure.

In preferred embodiments of the separator device, the covers are detachably interconnectable without tools by means of a plug-in connection, for example by means of laterally folded-over tabs of a cover, which can be inserted into recesses in the other cover intended for this purpose and are inserted therein to obtain a pre-separator unit.

The claims filed with the application are the proposed wording, without prejudice to achieving further protection. Since the features in the dependent claims can specifically form separate and independent inventions with regard to the prior art on the priority date, the applicant reserves the right to turn these or other combinations of features that were previously only disclosed in the description and/or the drawings into subject matter of independent claims or declarations of division. They can also contain standalone inventions which contain a configuration that is independent of the subjects of the claims in question.

An exemplary embodiment of the invention is explained in greater detail in the following with reference to the drawings. Objects or elements that correspond to one another are provided with the same reference signs in all the figures.

The exemplary embodiment should not be considered to limit the invention. Instead, in the context of the present disclosure, additions and modifications are entirely possible, in particular those that, for example by combining or modifying individual features or method steps described in connection with those described in the general or specific part of the description and found in the claims and/or the drawings, can be derived by a person skilled in the art with regard to the solution to the problem and, by way of combinable features, result in new subject matter or new method steps or method step sequences.

### BRIEF DESCRIPTION OF THE DRAWINGS

In the drawings:

FIG. 1 shows a known separator device comprising an inflow opening and an outflow opening,

FIG. 2 and FIG. 3 show a separator device comprising a closed inflow opening and a closed outflow opening, wherein the frame material closing both the inflow opening and the outflow opening can be used to obtain a pre-separator unit that can be attached to the separator device,

FIG. 4 and FIG. 5 show a separator device according to FIG. 2 and FIG. 3 comprising a pre-separator unit.

### DETAILED DESCRIPTION OF ILLUSTRATED EMBODIMENTS

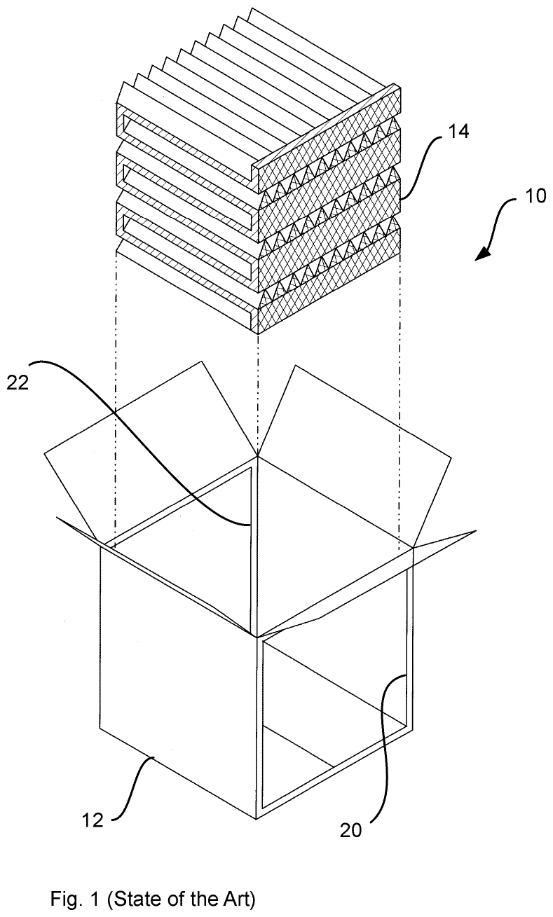

The view in FIG. 1 shows, by way of example and by means of the image elements of the view in FIG. 1 of EP 2 532 409 B, a separator device 10, specifically in the form of a snapshot during its production. A separator device and also the separator device 10 shown comprise an outer frame 12 and at least one separator element 14 in the frame 12. The frame 12 is a conventional cardboard box, for example, as is otherwise also used for packaging and/or shipping purposes. The at least one separator element 14 is placed in the frame 12. The dashed lines shown how and where the separator element 14 is placed in the frame 12. In the view in FIG. 1, the cardboard box (the frame 12) is still open in order to receive the separator element 14. After receiving the separator element 14, the cardboard box (the frame 12) is closed, for example glued shut.

In EP 2 532 409 B, the separator element 14 is a multilayer paper filter sheet. For the invention proposed here, it does not expressly come down to a particular type of separator element 14 or to a particular number of separator elements 14, and, accordingly, the separator device 10 is considered to be a separator device 10 intended for separating particles entrained in an air flow, in particular paint particles, comprising an outer frame 12 and at least one separator element 14 placed therein.

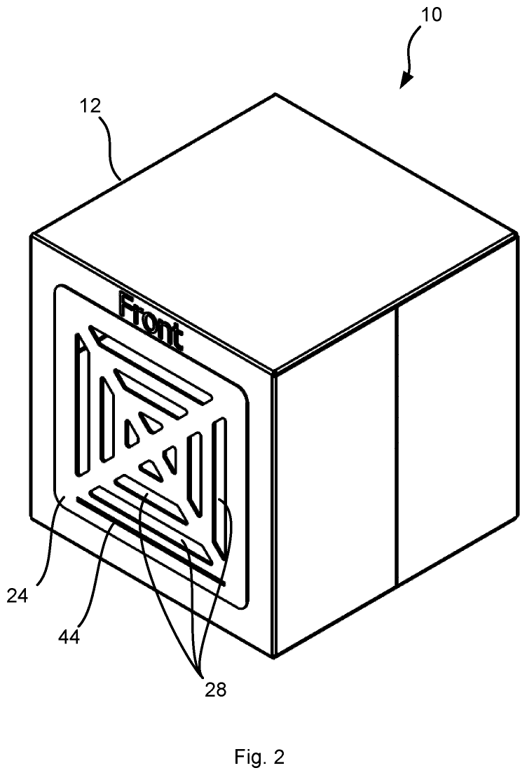

The frame 12 of the separator device 10 proposed here (FIG. 2 et seq.) acts as a housing. The frame 12 is a housing, namely a housing for the at least one separator element 14 in the interior of the frame 12 (in the interior of the housing). A cardboard box as mentioned above or as in EP 2 532 409 B always comes into consideration as a frame 12. Each mention of the term “frame” should always accordingly be interpreted as a cardboard box acting as a frame 12 and the term “frame” at least covers the term “cardboard box”, but also covers other options for receiving at least one separator element 14, for example a crate made of wood, metal, plastics material, or the like.

It is essential that the frame 12 comprises two large-area openings 20, 22. During operation, an air flow (raw gas flow) loaded with particles, for example paint particles, flows through the separator device 10. This flow enters the frame 12, and therefore the separator device 10 as a whole, through one of the openings 20, 22. One of the openings 20 is accordingly the entry opening or inflow opening 20. The raw gas flow exits the frame 12, i.e. the separator device 10, again through the other opening 22. This opening 22 is accordingly the exit opening or outflow opening 22. In the view in FIG. 1, each of the reference lines extends to a margin line of these openings 20, 22. When the raw gas flow flows through the separator device 10, it passes through the at least one separator element 14 in the interior of the frame 12, such that separation of particles entrained in the raw gas flow takes place in a manner known per se in principle.

In the delivery state of a separator device 10, the inflow opening 20 and the outflow opening 22 are usually closed. This for example ensures that the at least one separator element 14 located in the interior of the frame 12 is protected. Closed openings 20, 22 mean that the frame 12 is opened to produce openings 20, 22 through which media can flow. For this purpose, the shape and size of the openings 20, 22 are predetermined by a perforation or the like in the material of the frame 12, for example. The inflow and outflow openings 20, 22 are therefore opened by the frame material closing the openings 20, 22 being detached from the frame 12 at least in part in each case. The frame material delimited by a perforation or the like is referred to in the following as a cover 24, 26 (FIG. 2 et seq.). In view of the inflow and outflow openings 20, 22, the frame 12 comprises an inflow opening cover 24 and an outflow opening cover 26 and, when opening the inflow and outflow openings 20, 22, an inflow opening cover 24 and an outflow opening cover 26 result.

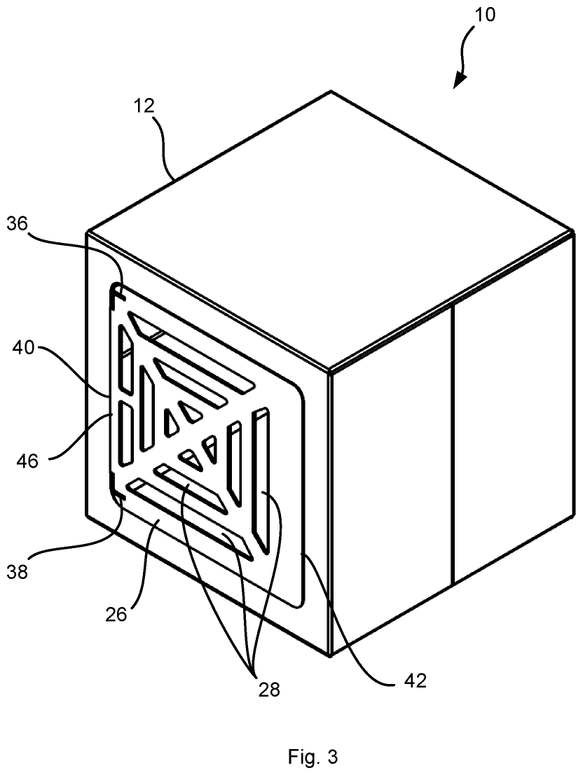

The views in FIG. 2 and FIG. 3 are isometric views of a separator device 10 in the delivery state. In the view in FIG. 2, the eye falls, inter alia, on the side face of the frame 12 which acts as the inflow side (the raw gas flow flows in therethrough) during operation and comprises the inflow opening 20, which is still closed (in the configuration shown) by means of the inflow opening cover 24. In the view in FIG. 3, the eye falls, inter alia, on the side face of the frame 12 which is opposite the inflow side during operation and comprises the outflow opening 22, which is still closed (in the configuration shown) by means of the outflow opening cover 26. When a separator device 10 is used to separate particles entrained in a raw gas flow, i.e. in the operationally ready state, the inflow opening 20 and the outflow opening 22 are open. In the view in FIG. 2, the inflow side is denoted by the text “front”, merely for orientation and for the purposes of differentiation.

The two covers 24, 26 (inflow opening cover 24, outflow opening cover 26) are preferably structured, for example by comprising a plurality of holes 28 (only some are labeled). The number, shape, and/or distribution of the holes 28 is not important, and the view in the drawings is expressly only an example. In the case of structuring of the covers 24, 26 by means of a plurality of holes 28, the covers 24, 26 are perforated. In other words: In the case of structuring of the parts 24, 26 by means of a plurality of holes 28, the covers 24, 26 have a grid-like form owing to the holes 28, with groups of differently sized holes 28 coming into consideration as holes 28, as shown by way of example.

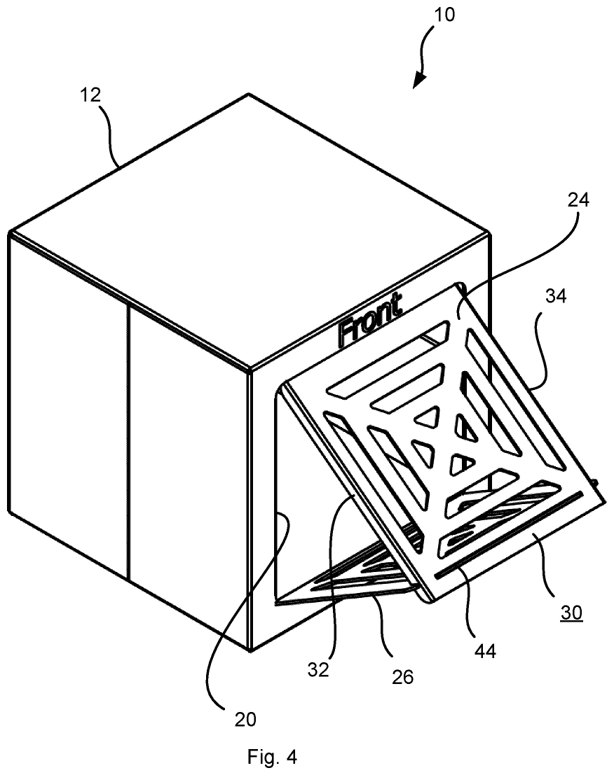

The view in FIG. 4 is an isometric view of the separator device 10 according to FIG. 2 and FIG. 3 with an open inflow opening 20 (the outflow opening 22, which is not visible, is also open), wherein the covers 24, 26 obtained when the openings 20, 22 (inflow and outflow opening 20, 22) are opened are combined to form a pre-separator unit 30. This combination of the two covers 24, 26 takes place after the openings 20, 22 are opened. The two covers 24, 26 can be combined to form a pre-separator unit 30 and can be arranged on the frame 12, and are combined with one another to obtain a pre-separator unit 30 and are arranged on the frame 12. The arrangement on the frame 12 takes place in and/or on the inflow opening 20.

In the claims and sometimes also in the following description, the two covers 24, 26 are generally referred to as the first cover 24 and the second cover 26, since certain features that are shown in the exemplary embodiment as being implemented on the inflow or outflow opening cover 24, 26 can equally be implemented on the outflow or inflow opening cover 26, 24. This interchangeability should always be inferred in the following. On the basis of the exemplary embodiment shown in the drawings, the first cover 24 is the inflow opening cover 24 and the second cover 26 is the outflow opening cover 26. This relates only to the exemplary embodiment shown in the drawings and should not be interpreted in a limiting manner.

In order to combine the two covers 24, 26, two opposite sides, provided for this purpose, of one of the two covers 24, 26 (in the exemplary embodiment of the first cover 24/the inflow opening cover 24) are folded over. The opposite sides are free sides of the inflow opening cover 24 after the inflow opening 20 is opened, such that these sides can be folded over.

They are folded over by an angle of 90° or at least substantially 90° relative to the remaining surface of the cover 24. By these sides being folded over, folded-over tabs 32, 34 (first tab 32, second tab 34) are formed on the opposite sides. In the view in FIG. 4, the second tab 34 is concealed by the cover 24 itself. When the covers 24, 26 are combined, these two tabs 32, 34 are inserted into marginal, slot-like recesses 36, 38 (FIG. 3) in the other cover 26 (in the exemplary embodiment of the second cover 26/the outflow opening cover 26) and are inserted therein when the covers 24, 26 are combined. The recesses 36, 38 are marginal recesses 36, 38 because they originate from one of the edges (the margin line) of the cover 26. The recesses 36, 38 are optionally oriented transversely to the adjacent margin line or at least substantially transversely to this margin line of the cover 26. The edge comprising the recesses 36, 38 is referred to as the first edge 40 for reference. The opposite edge is the second edge 42.

By being inserted into the recesses 36, 38, the tabs 32, 34 are fixed in the folded-over configuration. The folded-over tabs 32, 34 stabilize the cover 24. Each folded-over tab 32, 34 forms an L-shaped profile together with the adjacent surface of the cover 24, and this gives the cover 24 considerable stability.

To improve the stability of the combination of the two covers 24, 26, preferably, an elongate slot 44 is provided in one of the two covers 24 and a marginal, blade-like support portion 46 is provided on the other cover 26. In the exemplary embodiment, the cover 24 comprising the side tabs 32, 34 (the inflow opening cover 24; first cover 24) comprises the elongate slot 44, specifically in parallel with the edge closest to (adjacent to) the slot 44. Accordingly, the cover 26 comprising the marginal recesses 36, 38 (the outflow opening cover 26; second cover 26) comprises the blade-like support portion 46.

When combining the two covers 24, 26 (when inserting the tabs 32, 34 into the recesses 36, 38), the blade-like support portion 46 of the second cover 26 is inserted into the elongate slot 44 in the first cover 24 and, when the covers 24, 26 are combined, the blade-like support portion 46 of the second cover 26 is inserted into the elongate slot 44 in the first cover 24. The blade-like support portion 46 engages in the elongate slot 44.

In the embodiment shown, the blade-like or tongue-like support portion 46 (blade-like in the sense of a turbine blade; tongue-like in the sense of a tongue of a tongue and groove joint) is produced on the second cover 26 in the region of its first edge 40 by the second cover 26 being shortened in some pieces in the region of the recesses 36, 38 (i.e. in the region of its corners) and in the direction of the recesses 36, 38. A longer portion (longer in a longitudinal measurement along the cover 26 and transversely to its first edge 40) remains along the first edge 40 between the shortened portions in the region of the corners, and this region is referred to as the blade-like support portion 46 on the second cover 26.

One of the two covers 24 (in the exemplary embodiment of the cover 24 comprising the side tabs 32, 34/the first cover 24) is also connected to the previously closed opening 20, namely the inflow opening 20, and therefore to the frame 12 by some pieces after said opening that was previously closed by said cover is opened. This cover 24 is therefore the inflow opening cover 24.

The connection to the frame 12 is made along one of the edges of the inflow opening 20. This edge is one of the two horizontal or substantially horizontal edges in an intended or at least standard setup of the separator device 10, and specifically the upper of these two edges. The connection is made by the cover 24 remaining connected to the frame 12 at this edge, while it is detached from the frame 12 at the other three edges of the inflow opening 20 that was previously closed by the cover 24. The connection is a hinged connected of the film hinge type and the cover 24 is connected to the frame 12 so as to be pivotally movable at this edge (the cover 24 remains/is hinged to the frame 12 so as to be pivotally movable). In order to obtain a straight pivot axis, this edge is preferably perforated, for example. This perforation is a different perforation from the above-mentioned perforation, which makes it possible to detach the relevant cover 24, 26 from the frame 12, namely a less pronounced perforation, such that, when detaching the cover 24 from the inflow opening 20 (in the region of the three other edges), this edge does not tear out.

When combining the two covers 24, 26 to obtain a pre-separator unit 30, the inflow opening cover 24 is pivoted outward (protruding from the surface having the inflow opening 20 by an angle of <90°) and is pivoted outward for combination with the other cover 26 (the outflow opening cover 26). This combination is preferably made, as described above, at least by means of the side tabs 32, 34 and by inserting the tabs 32, 34 into the recesses 36, 38 provided for this purpose. Before or after combining the two covers 24, 26 with one another, the outflow opening cover 26, which has been completely detached from the outflow opening, is inserted into the inflow opening 20 by one of its free edges, the second edge 42. This free edge 42 is the edge of the outflow opening cover 26 which is opposite an edge in the region of which the two covers 24, 26 are combined with one another. When the two covers 24, 26 are combined by inserting the tabs 32, 34 of the inflow opening cover 24 into the recesses 36, 38 in the outflow opening cover 26 that are provided for this purpose, the free edge 42 is the edge which is opposite the edge 40 having the recesses 36, 38. The outflow opening cover 26 is inserted into the inflow opening 20 until its free edge 42 hits a limit provided for this purpose (a stop provided for this purpose) in the interior of the frame 12. The at least one separator element 14 in the interior of the frame 12 or one of the separator elements 14 in the interior of the frame 12 acts/act as a limit (stop), for example. The outflow opening cover 26 is therefore inserted into the inflow opening 20 only to a small extent and the majority of the outflow opening cover 26 remains outside the frame 12. The outflow opening cover 26 inserted into the inflow opening 20 engages in the frame 12 and its inflow opening 20 by its free edge 42.

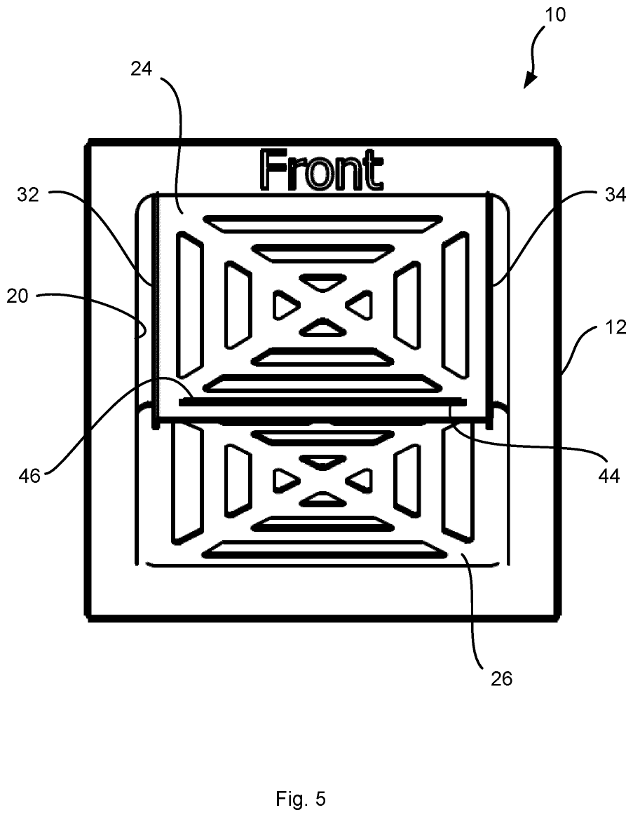

The view in FIG. 5 shows the separator device 10 according to FIG. 4 with the pre-separator unit 30 attached thereto, in a view looking centrally at the side of the separator device 10 comprising the inflow opening 20.

The portion of the outflow opening cover 26 inserted into the inflow opening 20, i.e. the free edge 42 of part of the free edge 42, can be folded over, and can be folded over in a pre-separator unit 30 attached to the separator device 10 and can be inserted into the inflow opening 20 by this folded-over portion. When inserted, the folded-over portion preferably stretches in the interior of the frame 12 as far as the base of the frame 12.

In the views in FIG. 2 and FIG. 3, three side faces of the frame 12 are visible in each case. One of the side faces comprises the relevant opening 20, 22 (inflow or outflow opening 20, 22). One of the side faces (in each of said figures, shown as the outward-facing face) is completely closed. The then remaining face of the three side faces shown is the base region or the cover region of the frame 12 (the cover region is closed after placing the at least one separator element 14 in the frame 12). On the basis of these side faces, the orientation of the openings 20, 22 and thus also the orientation of the covers 24, 26 is apparent. This is essential in the case of openings 20, 22 having unequal lengths of the respectively parallel edges (rectangular, non-square openings 20, 22). The longer edges of the openings 20, 22 determine the width of the openings 20, 22. The short edges of the openings 20, 22 determine their height. The width and the height of the two openings 20, 22 are identical or at least substantially identical in each case.

In the case of rectangular openings 20, 22 of this kind, the two covers 24, 26 are each rotated toward one another by 90° by their longest axis in the state in which they are still connected to the frame. When combining the two covers 24, 26, the outflow opening cover 26 is rotated after being removed from the outflow opening 22 such that its short edges 40, 42 are parallel to the long edges of the inflow opening 20. The distance between the long edges of the outflow opening cover 26 (measured transversely to the long edge) is less than the width of the inflow opening 20. The outflow opening cover 26 (or its free edge 42 or part of the free edge 42) can therefore be easily inserted into the inflow opening 20 when combining the two covers 24, 26 to obtain the pre-separator unit 30.

The frame 12 preferably receives the at least one separator element 14 in a tight fit. When said element is received in a tight fit, the at least one separator element 14 adjoins at least the side wall of the frame 12 comprising the inflow opening 20 and the opposite side wall at least with an initially small oversize and resulting compression of the separator element 14 or the relevant separator element 14. The free edge 42 inserted into the inflow opening 20 or part of the free edge 42 of the outflow opening cover 26 is then clamped there between the inside of the side face of the frame 12 comprising the inflow opening 20 and the at least one separator element 14 received in the frame 12 in a tight fit. This free edge is clamped between the inside of the side face of the frame 12 comprising the inflow opening 20 on one side and the at least one separator element 14 received in the frame 12 in a tight fit on the other side. It is clamped by the at least one separator element 14 received in the frame 12 in a tight fit pressing the free edge 42 or part of the free edge 42 of the outflow opening cover 26 against the inside of the side face of the frame 12 comprising the inflow opening 20. In this configuration, the clamped free edge 42 or part of the free edge 42 of the outflow opening cover 26 is particularly well fixed at least to an extent that is sufficient for use of the pre-separator unit 30 for separating particles entrained in a raw gas flow.

The user can completely remove the covers 24, 26 from the frame 12 without tools and dispose of them when it is not desired to use the covers 24, 26 as a pre-separator unit 30.

The covers 24, 26 can also be supplied separately, for example in the form of blanks having the shape described here and the properties described here. Covers 24, 26 of this kind then do not originate from the frame 12. Covers 24, 26 of this kind are also combined as described here. They are attached to a frame 12 of a separator device 10 by a form fit or by insertion, adhesion, stapling, or the like, for example.

The main individual aspects of the description submitted here can therefore be summarized as follows: Provided is a separator device 10 for separating particles entrained in a raw gas flow. The separator device 10 comprises a frame 12 for receiving at least one separator element 14 and two openings 20, 22, an inflow opening 20 and an outflow opening 22, in the frame 12 in the operationally ready state. The frame material closing the openings 20, 22 before the openings 20, 22 are opened can be used to obtain a pre-separator unit 30 that can be attached to the separator device 10. For this purpose, the frame material closing the openings 20, 22 before the openings 20, 22 are opened acts as the first cover 24 and the second cover 26. The two covers 24, 26 are combined to form a pre-separator unit 30 after the openings 20, 22 are opened and can be combined to form a pre-separator unit 30 after opening the openings 20, 22 and can be or are arranged on the frame 12 in the region of the inflow opening 20.

### LIST OF REFERENCE SIGNS

10 Separator device
12 Frame
14 Separator element
16, 18 (free)
20 Opening, inflow opening
22 Opening, outflow opening
24 Cover, first cover, inflow opening cover
26 Cover, second cover, outflow opening cover
28 Hole
30 Pre-separator unit
32 First side tab
34 Second side tab
36 Marginal recess
38 Marginal recess
40 First edge
42 Second edge
44 Slot
46 Support portion

1. A separator device (10) for separating particles entrained in a raw gas flow, and comprising a frame (12) for receiving at least one separator element (14) and two openings (20, 22), an inflow opening (20) and an outflow opening (22), in the frame (12) in the operationally ready state,
characterized in that
the frame material closing the openings (20, 22) before the openings (20, 22) are opened acts as a first cover (24) and a second cover (26), and
the two covers (24, 26) can be combined to form a pre-separator unit (30) after the openings (20, 22) are opened and can be arranged on the frame (12) in the region of the inflow opening (20).

2. The separator device (10) according to claim 1,
wherein one of the two covers (24) comprises side tabs (32, 34) formed by folding over two opposite sides, and
wherein, when the covers (24, 26) are combined to form a pre-separator unit (30), these side tabs (32, 34) engage in marginal recesses (36, 38) in the other cover (26).

3. The separator device (10) according to claim 2,
wherein the cover (24) comprising the side tabs (32, 34) is also connected to the relevant opening (20) by some pieces after said relevant opening is opened, and wherein this opening (20) is the inflow opening (20).

4. The separator device (10) according to claim 3,
wherein the cover (26) comprising the marginal recesses (36, 38) comprises them in a first edge (40) and this cover (26) comprises a second edge (42) opposite this first edge (40), and
wherein, when the covers (24, 26) are combined to form a pre-separator unit (30), the cover (26) comprising the marginal recesses (36, 38) is inserted into the inflow opening (20) by its second edge (42).

5. The separator device (10) according to claim 1,
wherein one of the two covers (24) comprises an elongate slot (44) extending in parallel with the adjacent edge, in which slot a marginal, blade-like support portion (46) on the other cover (26) engages when the covers (24, 26) are combined to form a pre-separator unit (30).

6. The use of frame material of a separator device (10) intended for separating particles entrained in a raw gas flow,
which separator device comprises a frame (12) for receiving at least one separator element (14) and two openings (20, 22) in the frame (12) in the operationally ready state,
wherein the frame material closes the openings (20, 22) before these openings (20, 22) are opened,
as covers (24, 26) of a separator device (10) according to claim 1 which can be combined to form a pre-separator unit (30).

7. The use of a separator device (10) according to claim 1 together with a pre-separator unit (30), combined therewith and made of frame material of the separator device (10), for separating particles entrained in a raw gas flow.

8. A method for obtaining a pre-separator unit (30) that can be used together with a separator device (10),
wherein the separator device (10) comprises a frame (12) for receiving at least one separator element (14) and two openings (20, 22), an inflow opening (20) and an outflow opening (22), in the frame (12) in the operationally ready state,
wherein the frame material closing the openings (20, 22) before the openings (20, 22) are opened acts as the first cover (24) and the second cover (26), and
wherein the two covers (24, 26) can be combined to obtain the pre-separator unit (30) after the openings (20, 22) are opened and the pre-separator unit (30) can be arranged on the frame (12) in the region of the inflow opening (20).

9. The method according to claim 8,
wherein side tabs (32, 34) are formed on one of the two covers (24) by folding over two opposite sides of said cover, and
wherein, when the covers (24, 26) are combined to form a pre-separator unit (30), these side tabs (32, 34) are inserted into marginal recesses (36, 38) in the other cover (26).

10. The method according to claim 8
wherein the cover (24) comprising the side tabs (32, 34) is also connected to the relevant opening (20) by some pieces after said relevant opening is opened,
wherein this opening (20) is the inflow opening (20),
wherein, when the covers (24, 26) are combined to form a pre-separator unit (30), the cover (24) remaining connected to the inflow opening (20) by some pieces is pivoted outward from the surface having the inflow opening (20) and
wherein the other cover (26) is completely detached from the opening (22), the outflow opening (22), and is combined with the cover (24) to obtain the pre-separator unit (30).
